(19) United States
(12) Patent Application Publication
(10) Pub. No.: US 2011/0165464 A1
(43) Pub. Date: Jul. 7, 2011

(54) Negative Electrode for Rechargeable Lithium Battery and Rechargeable Lithium Battery Including Same

(75) Inventors: Kyoung-Han YEW, Yongin-si (KR); Sang-Min LEE, Yongin-si (KR); Young-Jun LEE, Yongin-si (KR); Young-Hwan KIM, Yongin-si (KR)

(73) Assignee: Samsung SDI Co., Ltd., Yongin-si (KR)

(21) Appl. No.: 12/868,193

(22) Filed: Aug. 25, 2010

(30) Foreign Application Priority Data
Jan. 5, 2010 (KR) 10-2010-0000545

(51) Int. Cl. H01M 4/583; H01M 4/52; H01M 4/50

(52) U.S. Cl. 429/223; 429/231.8; 429/224

(57) ABSTRACT

A negative electrode for a rechargeable lithium battery and a rechargeable lithium battery including the same. The negative electrode includes a current collector and a negative active material layer disposed on the current collector, wherein the negative active material layer includes a negative active material including a silicon-based core and a carbon layer disposed on the surface of the silicon-based core, an inorganic salt including an alkaline metal cation selected from a Na cation, a K cation, or a combination of these; and an anion selected from a carbonate anion, a halogen anion, or a combination of these, and an aqueous binder.

### CLAIM OF PRIORITY

This application makes reference to, incorporates the same herein, and claims all benefits accruing under 35 U.S.C §119 from an application filed earlier filed in the Korean Intellectual Property Office on 5 Jan. 2010 and there duly assigned Serial No. 10-2010-0000545.

### BACKGROUND OF THE INVENTION

1. Field of the Invention

This disclosure relates to a negative electrode for a rechargeable lithium battery and a rechargeable lithium battery including the same, and more particularly, to a negative electrode for a rechargeable lithium battery and a rechargeable lithium battery having the negative electrode with the rechargeable lithium battery having an improved cycle life characteristic.

2. Description of the Related Art

Lithium rechargeable batteries have recently drawn attention as power sources for small portable electronic devices. The Lithium rechargeable batteries use an organic electrolyte solution and thereby have twice of the discharge voltage of a contemporary battery which uses an alkaline aqueous solution, therefore, the lithium rechargeable batteries have a higher energy density compared to that of the contemporary battery. The lithium rechargeable battery generally has a positive electrode including positive active material and a negative electrode including negative active material, and a separator may be interposed between the positive electrode and the negative electrode.

### SUMMARY OF THE INVENTION

It is therefore one object for the present invention to provide an improved negative electrode for a rechargeable lithium battery.

It is another object for the present invention to provide an improved negative electrode for a rechargeable lithium battery in order to improve the cycle life characteristic of the rechargeable lithium battery.

It is still another object for the present invention to provide an improved rechargeable lithium battery including the improved negative electrode.

In accordance with one aspect of this disclosure, a negative electrode for a rechargeable lithium battery is provided. The negative electrode includes a current collector and a negative active material layer disposed on the current collector. The negative active material layer includes a negative active material including a silicon-based core and a carbon layer disposed on the surface of the silicon-based core; an inorganic salt including an alkaline metal cation selected from a Na cation, a K cation, or a combination of these, and an anion selected from a carbonate anion, a halogen anion, or a combination of these; and an aqueous binder.

The silicon-based core may include Si, SiOₓ (0<x<2), a Si—Z alloy (where Z is an element selected from the group consisting of an alkaline metal, an alkaline-earth metal, a group 13 element, a group 14 element, a transition element, a rare earth element, and a combination of these, and not Si), or a combination of these.

The carbon layer may include an amorphous carbon. The carbon layer may include an amorphous carbon selected from the group consisting of soft carbon (low-temperature fired carbon), hard carbon, mesophase pitch carbide, fired coke and a mixture of these. The content of the carbon layer may range from about 1 part by weight to about 20 parts by weight based on 100 parts by weight of the negative active material. The thickness of the carbon layer may range from about 1 nm to about 100 nm.

The negative active material may have an average particle diameter of about 1 μm to about 20 μm.

The inorganic salt may include K₂CO₃, KCl, KF, Na₂CO₃, NaCl, NaF, or a combination of these. The content of the inorganic salt may range from about 0.1 part by weight to about 10 parts by weight based on 100 parts by weight of the total weight of the negative active material composition including negative active material, an inorganic salt, and an aqueous binder.

The aqueous binder may include one selected from carboxylmethylcellulose, polyvinylchloride, polyacrylic acid, a styrene-butadiene rubber, or a combination of these.

Also, in accordance with yet another aspect of this disclosure, a rechargeable lithium battery is provided that includes the negative electrode, a positive electrode including a positive active material, and a non-aqueous electrolyte.

The negative electrode for a rechargeable lithium battery provides a rechargeable lithium battery having excellent cycle life.

### BRIEF DESCRIPTION OF THE DRAWING

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded oblique view of a rechargeable lithium battery constructed as one embodiment.

### DETAILED DESCRIPTION OF THE INVENTION

Exemplary embodiments will hereinafter be described in detail. These embodiments are however exemplary, and this disclosure is not limited to these embodiments.

For positive active materials used in a rechargeable lithium battery, researchers have been done research on lithium-transition element composite oxides which are capable of intercalating lithium such as LiCoO₂, LiMn₂O₄, LiNi_₁₋ₓCoₓO₂ (0<x<1), and other similar material.

For negative active materials used in a rechargeable lithium battery, various carbon-based materials such as artificial graphite, natural graphite, and hard carbon, which can all intercalate and deintercalate lithium ions, have been used.

Graphite of the carbon-based material has a low discharge potential of −0.2V compared to lithium, and a battery using graphite as a negative active material may have a high discharge potential of 3.6V and an excellent energy density. Furthermore, graphite may guarantee a long cycle life for a battery because of the outstanding reversibility of the graphite.

A graphite active material however has a low density (theoretical density of 2.2 g/cc where the unit g/cc refers to grams per cubic centimeter), therefore, the graphite active material has a low capacity in terms of energy density per unit volume when using the graphite as a negative active material.

Further, the graphite may involve swelling or capacity reduction when a battery is misused or overcharged and the like, because graphite may react with an organic electrolyte at a high discharge voltage.

In order to solve these problems, researchers have recently done a great deal of research on oxides such as tin oxide, lithium vanadium oxides.

Such an oxide negative electrode however does not sufficiently improve the performance of the battery, therefore, further research on the oxide negative materials is urgently required.

The negative electrode for a rechargeable lithium battery constructed as one embodiment includes a current collector and a negative active material layer disposed on the current collector. The negative active material layer includes a negative active material including a silicon-based core and a carbon layer disposed on the surface of the silicon-based core; an inorganic salt including an alkaline metal cation selected from a Na cation, a K cation, or a combination of these, and an anion selected from a carbonate anion, a halogen anion, or a combination of these; and an aqueous binder.

The current collector may be selected from the group consisting of a copper foil, a nickel foil, a stainless steel foil, a titanium foil, a nickel foam, a copper foam, a polymer substrate coated with a conductive metal, and combinations of these.

The negative active material layer may be acquired by a negative active material composition including a negative active material, an inorganic salt, and an aqueous binder. Hereinafter, the constituent elements of the negative active material composition are described.

The negative active material includes a silicon-based core and a carbon layer disposed on the surface of the silicon-based core.

The silicon-based core includes one selected from Si, SiOₓ (0<x<2), a Si—Z alloy (where Z is an element selected from the group consisting of an alkaline metal, an alkaline-earth metal, a group 13 element, a group 14 element, a transition element, a rare earth element, and a combination of these, and not Si), or a combination of these. The element Z is selected from the group consisting of Mg, Ca, Sr, Ba, Ra, Sc, Y, La, Ti, Zr, Hf, V, Nb, Ta, Cr, Mo, W, Tc, Re, Fe, Ru, Os, Co, Rh, Ir, Ni, Pd, Pt, Cu, Ag, Au, Zn, Cd, B, Ge, P, As, Sb, Bi, S, Se, Te, Po, and a combination of these. Group 13 elements currently include boron (B), aluminium (Al), gallium (Ga), indium (In), thallium (Tl), and ununtrium (Uut). Group 14 elements currently include carbon (C), silicon (Si), germanium (Ge), tin (Sn), lead (Pb), and ununquadium (Uuq).

The surface of the silicon-based core may be coated with a carbon layer. The carbon layer may include an amorphous carbon. The amorphous carbon may be at least one selected from the group consisting of soft carbon (low-temperature fired carbon), hard carbon, mesophase pitch carbide, fired coke, and a mixture of these.

The amorphous carbon may be included in a content ranging from about 1 part by weight to about 20 parts by weight based on the total weight of the negative active material. When the content of the amorphous carbon falls in the above range, the rechargeable lithium battery including the negative active material may form a wide conduction network and maintain a conduction path between active materials having a relatively low conductivity. Thus, the electric conductivity of the rechargeable lithium battery may be improved.

The carbon layer may have a thickness ranging from about 1 nm to about 100 nm. When the carbon layer is excessively thin, the rechargeable lithium battery does not have sufficient conduction path. When the carbon layer is excessively thick, the battery capacity may be deteriorated. When the thickness of the carbon layer is within the range, the electric conductivity of the rechargeable lithium battery including the negative active material may be improved.

The carbon layer is formed by coating the silicon-based core with amorphous carbon. The amorphous carbon may be selected from the group consisting of soft carbon (low-temperature fired carbon), hard carbon, mesophase pitch carbide, fired coke and a mixture of these. The coating method for the carbon layer is not limited to the above method and a dry coating or a liquid coating may be used. Examples of the dry coating method include a deposition method and a chemical vapor deposition (CVD) method, and examples of the liquid coating include an impregnation method, and a spray method. When the liquid coating is used, Dimethyl sulfoxide (DMSO) or Tetrahydrofuran (THF) may be used as a solvent, and the concentration of carbon material in the solvent may range from about 1 wt % to about 20 wt %.

Also, the carbon layer may be formed by coating a core formed of a Si-based material with a carbon precursor and heating the coated core in the atmosphere of an inert gas such as argon or nitrogen at a temperature of about 400° C. to about 1200° C. for about 1 hour to about 10 hours. While the heat treatment is performed, the carbon precursor is carbonized and transformed into amorphous carbon, and thus an amorphous carbon layer is formed on the surface of the core. Non-limiting examples of the carbon precursor include coal pitch, mesophase pitch, petroleum pitch, coal oil, petroleum heavy oil, and polymer resin such as phenol resin, furan resin, and polyimide resin, however, the carbon precursor is not limited to the above examples. In particular, a vinyl-based resin such as polyvinylidene fluoride (PVDF), polyvinylchloride (PVC), and the like, a conductive polymer such as polyaniline (PAn), polyacetylene, polypyrrole, polythiophene, and the like, may be used to form the carbon precursor, and the conductive polymer may be doped with hydrochloric acid.

The prepared negative active material may have an average particle diameter of about 1 μm to about 20 μm. When the average particle diameter is within the above range, side reaction is suppressed and diffusion rate in particles is maintained at a desirable level resulting in improvement of charge and discharge characteristics.

The inorganic salt may be selected from the group consisting of a salt of alkaline cation and carbonate anion, a salt of alkaline cation and halogen anion, and a combination of these. The inorganic salt may be selected from the group consisting of K₂CO₃, KCl, KF, Na₂CO₃, NaCl, NaF, or a combination of these.

The content of the inorganic salt may range from about 0.1 part by weight to about 10 parts by weight based on 100 parts by weight of the total weight of the negative active material including negative active material, an inorganic salt, and an aqueous binder. When the content of the inorganic salt falls in the above range, the battery capacity of the rechargeable lithium battery including the negative active material is not reduced.

The content of the inorganic salt may be somewhat different within the range in accordance with the kind of the inorganic salt. For example, when the inorganic salt includes K as a cation, the content of the inorganic salt may range from about 5 parts by weight to about 10 parts by weight based on 100 parts by weight of the total weight of the active material composition; when the inorganic salt includes Na as a cation, the content may range from about 1 part by weight to about 10 parts by weight based on 100 parts by weight of the total weight of the active material composition. The content of the inorganic salt may be controlled by those of an ordinary skill in the art within the range according to the kind, concentration or coating conditions of an inorganic salt coating liquid.

The inorganic salt may be added to an aqueous binder, or the inorganic salt is dissolved in a solvent to obtain a solution and the solution is added to an aqueous binder. The solvent may be selected from the group consisting of water, alcohol, acetone, tetrahydrofuran, and a combination of these. The concentration of the inorganic salt may range from about 5 wt % to about 20 wt %.

The binder improves binding properties of the negative active material particles to each other and to a current collector. In one embodiment, the binder may be an aqueous binder. The aqueous binder may refer to a binder dissolved or dispersed in water.

Examples of the aqueous binder include a rubber-based binder such as a styrene-butadiene rubber, an acrylated styrene-butadiene rubber, an acrylonitrile-butadiene rubber, an acryl rubber, a butyl rubber, a fluorine rubber, and the like, polytetrafluoroethylene, polyethylene, polypropylene, an ethylenepropylene copolymer, polyethyleneoxide, polyvinylpyrrolidone, polyepichlorohydrin, polyphosphazene, polyacrylonitrile, polystyrene, an ethylene propylene diene copolymer, polyvinylpyridine, a chlorosulfonated polyethylene, latex, a polyester resin, an acryl resin, a phenol resin, an epoxy resin, polyvinyl alcohol, or a combination of these, but are not limited thereto.

When the aqueous binder is used, a thickener may be further included. The thickener is a material that gives viscosity and ion conductivity to the aqueous binder that does not have viscosity. Examples of the thickener include carboxylmethyl cellulose (CMC), hydroxypropylmethyl cellulose and a combination of these but are not limited thereto.

The thickener may be included in a content ranging from about 0.1 part by weight to about 10 parts by weight based on 100 parts by weight of the binder. When the thickener is included within the range, it is possible to prevent a phenomenon that an electrode plate becomes hard while preventing a sedimentation phenomenon at the same time.

The negative electrode may further include a conductive material as needed. The conductive material is used to give conductivity to an electrode, and any electroconductive materials that do not cause a chemical change may be used. Non-limiting examples of the conductive material include natural graphite, artificial graphite, and a mixture of conductive materials such as polyphenylene derivatives, however, the conductive material is not limited to the above examples.

The negative electrode may be fabricated by a method including mixing the negative active material, aqueous binder, and thickener and inorganic salt in a solvent to provide a negative active material composition and coating a current collector with the composition. The negative active material composition may further include a conductive material. The solvent may be N-methylpyrrolidone, water, and the like, but the solvent is not limited thereto.

In accordance with another embodiment, a rechargeable lithium battery including the negative electrode, a positive electrode including a positive active material, and a non-aqueous electrolyte is provided.

The negative electrode is the same as the above negative electrode for a rechargeable lithium battery, therefore, the description of the negative electrode will not be repeated.

The positive electrode includes a current collector and a positive active material layer disposed on the current collector. The positive active material includes lithiated intercalation compounds that reversibly intercalate and deintercalate lithium ions. The positive active material may include a composite oxide including at least one selected from the group consisting of cobalt, manganese, and nickel, as well as lithium. In particular, the following lithium-containing compounds may be used as the positive active material:

LiₐA_{1-b}X_{b}D₂ (0.90≦a≦1.8, 0≦b≦0.5); LiₐE_{1-b}X_{b}O_{2-c}D_{c} (0.90≦a≦1.8, 0≦b≦0.5, 0≦c≦0.05); LiE_{2-b}X_{b}O_{4-c}D_{c} (0≦b≦0.5, 0≦c≦0.05); LiₐNi_{1-b-c}Co_{b}X_{c}D_{α} (0.90≦a≦1.8, 0≦b≦0.5, 0≦c≦0.05, 0≦α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂(0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α<2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GeO₂ (0.90≦a≦1.8, 0≦b≦0.9, 0≦c≦0.5, 0≦d≦0.5, 0.001≦e≦0.1); LiₐNiG_{b}O₂(0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QO₂; QS₂; LiQS₂, V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); LiFePO₄.

In the above formulae, A is selected from the group consisting of Ni, Co, Mn, and a combination of these; X is selected from the group consisting of Al, Ni, Co, Mn, Cr, Fe, Mg, Sr, V, a rare earth element, and a combination of these; D is selected from the group consisting of O, F, S, P, and a combination of these; F si selected from the group consisting of Co, Mn, and a combination of these; T is selected from the group consisting of F, S, P, and a combination of these; G is selected from the group consisting of Al, Cr, Mn, Fe, Mg, La, Ce, Sr, V, and a combination of these; Q is selected from the group consisting of Ti, Mo, Mn, and a combination of these; Z is selected from the group consisting of Cr, V, Fe, Sc, Y, and a combination of these; and J is selected from the group consisting of V, Cr, Mn, Co, Ni, Cu, and a combination of these.

The compound may have a coating layer on the surface, or the compound may be used after being mixed with another compound having a coating layer thereon. The coating layer may include at least one coating element compound selected from the group consisting of oxide and hydroxide of a coating element, oxyhydroxide of a coating element, oxycarbonate of a coating element, and hydroxycarbonate of a coating element, and a combination of these. The compound that forms the coating layer may be amorphous or crystalline. The coating element included in the coating layer may be at least one selected from the group consisting of Mg, Al, Co, K, Na, Ca, Si, Ti, V, Sn, Ge, Ga, B, As, Zr, or a mixture thereof. The coating layer may be formed of the aforementioned compounds and elements by any forming method, such as spray coating and impregnation, as long as the forming method does not deteriorate the physical properties of the positive active material. Since this method is obvious to those skilled in the art to which this disclosure pertains, this method will not be described herein in detail.

The positive active material layer also includes a binder and a conductive material.

The binder improves binding properties of the positive active material particles to one another, and also with a current collector. Examples of the binder include at least one selected from the group consisting of polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited to the above examples.

The conductive material is included to improve electrode conductivity. Any electrically conductive material may be used as a conductive material unless the conductive material causes a chemical change. Examples of the conductive material include one or more of carbon black, acetylene black, ketjen black, carbon fiber, a metal powder or a metal fiber including copper, nickel, aluminum, or silver, and polyphenylene derivatives.

The current collector may be formed of Al, however, is not limited thereto.

The positive electrode may be fabricated by a method including mixing the positive active material, a conductive material and a binder in a solvent to provide a positive active material composition and coating a current collector with the composition. The electrode manufacturing method is well known, and thus will not be described in detail in the present specification. The solvent may be N-methylpyrrolidone, water, and the like, however, the solvent is not limited thereto.

In a rechargeable lithium battery constructed as one embodiment, a non-aqueous electrolyte includes a non-aqueous organic solvent and a lithium salt.

The non-aqueous organic solvent serves as a medium for transmitting ions taking part in the electrochemical reaction of the battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), fluoroethylene carbonate (FEC), propylene carbonate (PC), butylene carbonate (BC), and the like. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone, and the like. Examples of the alcohol-based solvent include ethyl alcohol, isopropyl alcohol, and the like, and examples of the aprotic solvent include nitrites such as R—CN (wherein R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio may be controlled in accordance with a desirable battery performance.

The carbonate-based solvent may include a mixture of a cyclic carbonate and a linear carbonate. The cyclic carbonate and the chain carbonate are mixed together in the volume ratio of about 1:1 to about 1:9, and when the mixture is used as an electrolyte, the electrolyte performance may be enhanced.

In addition, the non-aqueous organic electrolyte may further include mixtures of carbonate-based solvents and aromatic hydrocarbon-based solvents. The carbonate-based solvents and the aromatic hydrocarbon-based solvents may be mixed together in the volume ratio of about 1:1 to about 30:1.

The aromatic hydrocarbon-based organic solvent may be represented by the following Chemical Formula 1.

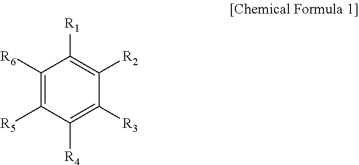

In the above Chemical Formula 1, R₁ to R₆ are independently hydrogen, a halogen, a C1 to C10 alkyl, a C1 to C10 haloalkyl, or a combination of these.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-d fluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or combinations of these.

The non-aqueous electrolyte may further include vinylene carbonate or an ethylene carbonate-based compound of the following Chemical Formula 2.

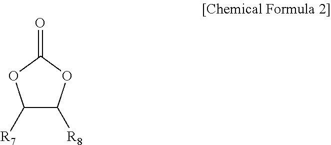

In the above Chemical Formula 2, R₇ and R₈ may independently be one of a hydrogen, a halogen, a cyano (CN), a nitro (NO₂), a C1 to C5 fluoroalkyl, a member of unsaturated aromatic hydrocarbon group, and a member of a unsaturated aliphatic hydrocarbon group, providing that at least one of R₇ and R₈ is one of a halogen, a nitro (NO₂), and a C1 to C5 fluoroalkyl, and that R₇ and R₈ are not simultaneously hydrogen.

The unsaturated aromatic hydrocarbon group includes a phenyl, a cyclo 1,3-pentadiene group, and the like, and the unsaturated aliphatic hydrocarbon group includes ethylene, propylene, butadiene, pentadiene, or hexatriene, and the like. The use amount of the additive for improving cycle life may be adjusted within an appropriate range.

The lithium salt supplies lithium ions in the battery, operates a basic operation of a rechargeable lithium battery, and improves lithium ion transport between positive and negative electrodes. Non-limiting examples of the lithium salt include at least one supporting salt selected from LiPF₆, LiBF₄, LiSbF₆, LiAsF₆, LiN (SO₂C₂F₅)₂, Li (CF₃SO₂)₂N, LiC₄F₉SO₃, LiClO₄, LiAlO₂, LiAlCl₄, LiN (CₓF₂ₓ₊₁SO₂, C_{y}F_{2y+1}SO₂, (where x and y are natural numbers), LiCl, LiI, and LiB(C₂O₄)₂ (lithium bisoxalato borate, LiBOB). The lithium salt is however not limited to the above examples. The lithium salt may be used in a concentration ranging from about 0.1 M (Molarity) to about 2.0 M (Molarity). When the lithium salt is included at the above concentration range, electrolyte performance and lithium ion mobility may be enhanced due to optimal electrolyte conductivity and viscosity.

The rechargeable lithium battery may further include a separator between a negative electrode and a positive electrode, as needed. Non-limiting examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

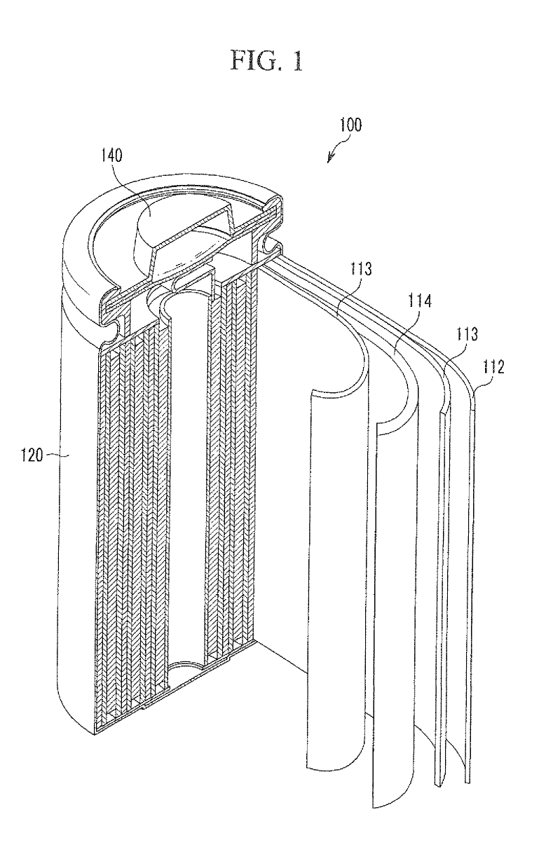

FIG. 1 is an exploded oblique view of a representative structure of a rechargeable lithium battery. FIG. 1 illustrates a cylindrical rechargeable lithium battery 100, which includes a negative electrode 112, a positive electrode 114, a separator 113 interposed between the negative electrode 112 and the positive electrode 114, an electrolyte (not shown) impregnating the separator 113, a battery case 120, and a sealing member 140 sealing the battery case 120. The negative electrode 112, positive electrode 114, and separator 113 are sequentially stacked, spirally wound, and are placed into a battery case 120 to fabricate such a rechargeable lithium battery 100.

The following examples illustrate this disclosure in more detail. These examples, however, are not in any sense to be interpreted as limiting the scope of this disclosure.

### Example 1

1) Fabrication of Negative Electrode

Si particles with a carbon layer are acquired by mixing Si particles with petroleum pitch, and performing a heat treatment in the atmosphere of nitrogen (N₂) at about 900° C. for about 6 hours. Through the heat treatment, the petroleum pitch is carbonized and the carbon layer including a hard carbon is formed on the surface of the Si particles. The thickness of the carbon layer is about 90 nm. The negative active material has an average particle diameter of about 5 μm. Also, the content of the Si particles of the negative active material is about 94 parts by weight based on 100 parts by weight of the negative active material, and the content of the amorphous carbon is about 5 parts by weight.

A negative active material composition is prepared by mixing the negative active material, a binder including polyacrylic acid and polyvinyl alcohol at a weight ratio of 50:50, an inorganic salt, K₂CO₃, and a graphite conductive material in a weight ratio of 60:10:1:29.

A negative electrode is fabricated through a typical electrode fabrication process in which a Cu-foil current collector is coated with the negative active material composition.

2) Fabrication of Positive Electrode

A positive active material slurry is prepared by mixing LiCoO₂ positive active material, a polyvinylidene fluoride binder and a carbon black conductive material into N-methylpyrrolidone solvent. Herein, the mixing ratio of the positive active material, the binder and the conductive material is about 94:3:3. A positive electrode is fabricated by a typical electrode fabrication process in which an Al-foil current collector is coated with the positive active material slurry.

3) Fabrication of Rechargeable Lithium Battery Cell

A rechargeable lithium battery cell is fabricated through a typical process by using the positive electrode, the negative electrode and a non-aqueous electrolyte. As for the non-aqueous electrolyte, a mixed solvent (a volume ratio of about 3:7) of ethylene carbonate and ethylmethylcarbonate where 1.0M of LiPF₆ is dissolved is used.

### Example 2

A negative electrode is fabricated according to the same method as in Example 1 except for using KCl as an inorganic salt, instead of K₂CO₃. The content of the inorganic salt is about 1 part by weight based on 100 parts by weight of the negative active material composition.

A rechargeable lithium battery cell is fabricated according to the same method as in Example 1 by using the negative electrode.

### Example 3

A negative electrode is fabricated according to the same method as in Example 1 except for using KF as an inorganic salt, instead of K₂CO₃. The content of the inorganic salt is about 1 part by weight based on 100 parts by weight of the negative active material composition.

A rechargeable lithium battery cell is fabricated according to the same method as in Example 1 by using the negative electrode.

### Example 4

A negative electrode is fabricated according to the same method as in Example 1 except for using Na₂CO₃ as an inorganic salt, instead of K₂CO₃. The content of the inorganic salt is about 1 part by weight based on 100 parts by weight of the total weight of the negative active material composition.

A rechargeable lithium battery cell is fabricated according to the same method as in Example 1 by using the negative electrode.

### Example 5

A negative electrode is fabricated according to the same method as in Example 1 except for using NaCl as an inorganic salt, instead of K₂CO₃. The content of the inorganic salt is about 1 part by weight based on 100 parts by weight of the negative active material composition.

A rechargeable lithium battery cell is fabricated according to the same method as in Example 1 by using the negative electrode.

### Example 6

A negative electrode is fabricated according to the same method as in Example 1 except for using NaF as an inorganic salt, instead of K₂CO₃. The content of the inorganic salt is about 1 part by weight based on 100 parts by weight of the total weight of the negative active material composition.

A rechargeable lithium battery cell is fabricated according to the same method as in Example 1 by using the negative electrode.

### Example 7

A negative electrode is fabricated according to the same method as in Example 1, except that the content of the inorganic salt is about 3 part by weight based on 100 parts by weight of the total weight of the negative active material composition.

A rechargeable lithium battery cell is fabricated according to the same method as in Example 1 by using the negative electrode.

### Example 8

A negative electrode is fabricated according to the same method as in Example 1, except that the content of the inorganic salt is about 5 part by weight based on 100 parts by weight of the total weight of the negative active material composition.

A rechargeable lithium battery cell is fabricated according to the same method as in Example 1 by using the negative electrode.

### Example 9

A negative electrode is fabricated according to the same method as in Example 2, except that the content of the inorganic salt is about 3 part by weight based on 100 parts by weight of the total weight of the negative active material composition.

A rechargeable lithium battery cell is fabricated according to the same method as in Example 1 by using the negative electrode.

### Example 10

A negative electrode is fabricated according to the same method as in Example 2, except that the content of the inorganic salt is about 5 part by weight based on 100 parts by weight of the total weight of the negative active material composition.

A rechargeable lithium battery cell is fabricated according to the same method as in Example 1 by using the negative electrode.

### Example 11

A negative electrode is fabricated according to the same method as in Example 3, except that the content of the inorganic salt is about 3 part by weight based on 100 parts by weight of the total weight of the negative active material composition.

A rechargeable lithium battery cell is fabricated according to the same method as in Example 1 by using the negative electrode.

### Example 12

A negative electrode is fabricated according to the same method as in Example 3, except that the content of the inorganic salt is about 5 part by weight based on 100 parts by weight of the total weight of the negative active material composition.

A rechargeable lithium battery cell is fabricated according to the same method as in Example 1 by using the negative electrode.

### Comparative Example 1

Si particles with a carbon layer are acquired by mixing Si particles with petroleum pitch, and performing a heat treatment in the atmosphere of nitrogen (N₂) at about 900° C. for about 6 hours. The thickness of the carbon layer is about 90 nm. The negative active material has an average particle diameter of about 5 pin.

A negative electrode is fabricated according to the same method as in Example 1 except for using no inorganic salt, and a rechargeable lithium battery cell is fabricated according to the same method as in Example 1 by using the negative electrode.

### Comparative Example 2

A negative electrode for a rechargeable lithium battery is fabricated according to the same method as in Example 1 except for using Li₂CO₃ as an inorganic salt, instead of K₂CO₃. The content of the inorganic salt is about 1 part by weight based on 100 parts by weight of the total weight of the negative active material composition.

A rechargeable lithium battery cell is fabricated according to the same method as in Example 1 by using the negative electrode.

### Comparative Example 3

A negative electrode for a rechargeable lithium battery is fabricated according to the same method as in Example 1 except for using LiCl as an inorganic salt, instead of K₂CO₃. The content of the inorganic salt is about 1 part by weight based on 100 parts by weight of the total weight of the negative active material composition.

A rechargeable lithium battery cell is fabricated according to the same method as in Example 1 by using the negative electrode.

The rechargeable lithium battery cells fabricated according to Examples 1 to 12 and Comparative Examples 1 to 3 are charged and discharged once at about 0.1 C (C-Rate), and their charge capacity, discharge capacity and initial efficiency are measured. The results are as shown in the following Table 1. 0.1 C (C-Rate) describes that a secondary battery may be fully charged or discharged in about 10 hours.

TABLE 1

| | | Content of | | | |
|---|---|---|---|---|---|
| | | Inorganic | | | |
| | | salts | Charge | Discharge | Initial |
| | Inorganic | (parts by | capacity | Capacity | efficiency |
| Example | salts | weight) | (mAh/g) | (mAh/g) | (%) |
| Comparative | — | — | 1358.18 | 1031.08 | 75.92 |
| Example 1 | | | | | |
| Comparative | Li₂CO₃ | 1 | 1293.35 | 985.64 | 76.21 |
| Example 2 | | | | | |
| Comparative | LiCl | 1 | 1360.33 | 1010.73 | 74.30 |
| Example 3 | | | | | |
| Example 1 | K₂CO₃ | 1 | 1296.35 | 1023.00 | 78.91 |
| Example 2 | KCl | 1 | 1444.20 | 1121.73 | 77.67 |
| Example 3 | KF | 1 | 1357.31 | 1069.31 | 78.78 |
| Example 4 | Na₂CO₃ | 1 | 1280.18 | 1005.13 | 78.51 |
| Example 5 | NaCl | 1 | 1429.32 | 1101.69 | 77.08 |
| Example 6 | NaF | 1 | 1353.84 | 1053.42 | 77.81 |
| Example 7 | K₂CO₃ | 3 | 1320.11 | 1036.53 | 78.52 |
| Example 8 | K₂CO₃ | 5 | 1318.61 | 1033.71 | 78.39 |
| Example 9 | KCl | 3 | 1478.79 | 1156.47 | 78.20 |
| Example 10 | KCl | 5 | 1485.54 | 1143.48 | 76.97 |
| Example 11 | KF | 3 | 1428.64 | 1101.66 | 77.11 |
| Example 12 | KF | 5 | 1398.93 | 1095.05 | 78.28 |

In Table 1, the contents of the inorganic salts are indicated as contents based on 100 parts by weight of the negative active material composition.

As shown in Table 1, the rechargeable lithium battery cells according to Examples 1 through 12 show remarkably improved charge efficiency, discharge efficiency and initial efficiency compared to that of Comparative Example 1. Comparing the charge capacity, discharge capacity and initial efficiency of the rechargeable lithium battery cells according to Examples 1 through 12, and Comparative Examples 2 and 3, the rechargeable lithium battery cells according to the Examples including negative active material composition including an inorganic salt of a K cation or a Na cation show more excellent initial efficiency than that including inorganic salt including a Li cation according to the Comparative Examples.

The exothermic heats and exothermic peak temperatures of the negative active materials of the rechargeable lithium battery cells fabricated according to Examples 1 through 12 and Comparative Examples 1 through 3 which are obtained by disassembling electrode plates in a charged state are measured by using a differential scanning calorimetry (DSC), and a DSC ascending temperature curve is drawn by ascending the temperature from about 50° C. 0.17 to about 400° C. in the atmosphere of nitrogen gas (30 ml/min) at a temperature ascending rate of about 10° C./min. The results are as shown in Table 2. The differential scanning calorimetry (DSC) is Q2000 differential scanning calorimetry produced by TA Instrument company. The measurement instrument is pressure cell with gold seal sealing.

TABLE 2

| | | Content of | |
|---|---|---|---|
| | Inorganic | inorganic salts | Exothermic heat |
| | salt | (parts by weight) | (%) |
| Comparative | — | — | 100 |
| Example 1 | | | |
| Comparative | Li₂CO₃ | 1 | 30 |
| Example 2 | | | |
| Comparative | LiCl | 1 | 25 |
| Example 3 | | | |
| Example 1 | K₂CO₃ | 1 | 10 |
| Example 2 | KCl | 1 | 5 |
| Example 3 | KF | 1 | 5 |
| Example 7 | K₂CO₃ | 3 | 5 |
| Example 8 | K₂CO₃ | 5 | 5 |
| Example 9 | KCl | 3 | 5 |
| Example 10 | KCl | 5 | 0 |
| Example 11 | KF | 3 | 5 |
| Example 12 | KF | 5 | 10 |

In Table 2, the contents of the inorganic salts are indicated as contents based on 100 parts by weight of the negative active material composition.

As shown in Table 2, the negative active materials obtained from the rechargeable lithium battery cells according to Examples show excellent thermal stability compared with that obtained from the rechargeable lithium battery cells according to Comparative Examples 1 through 3.

Referring to Table 2, the negative active materials obtained from the rechargeable lithium battery cells according to Examples 1 through 3 and 7 through 12 show exothermic peak temperature of about 350° C. or more. Also, the exothermic heats of Table 2 are relative values determined when it is assumed that the exothermic heat of Comparative Example 1 is 100. It may be seen from Table 2 that the exothermic heats of Examples 1-3 and 7-12 are reduced, compared to that of the Comparative Example 1.

The capacity retentions (i.e., cycle life) of the rechargeable lithium battery cells fabricated according to Examples 1 through 12 and Comparative Examples 1 through 3 are measured. The results of Examples 1 through 3 and Comparative Examples 1 through 3 are as shown in the following Table 3. The capacity retentions (i.e., cycle life characteristics) are measured by performing a charge and discharge at about 0.5 C (C-Rate) under about 25° C. for about 50 times. The measurement result is shown as a ratio of a discharge capacity at the 50^{th} cycle to a discharge capacity at the first cycle. 0.5 C (C-Rate) describes that a secondary battery may be fully charged or discharged in about 2 hours.

TABLE 3

| | | Content of | Capacity |
|---|---|---|---|
| | Inorganic | inorganic salts | retentions |
| | salt | (parts by weight) | (%) |
| Comparative Example 1 | — | — | 55 |
| Comparative Example 2 | Li₂CO₃ | 1 | 65 |
| Comparative Example 3 | LiCl | 1 | 60 |
| Example 1 | K₂CO₃ | 1 | 70 |
| Example 2 | KCl | 1 | 75 |
| Example 3 | KF | 1 | 85 |

In Table 3, the contents of the inorganic salts are indicated as contents based on 100 parts by weight of the negative active material composition.

Referring to Table 3, the capacity retention of the rechargeable lithium battery cells fabricated according to Examples 1 through 3 at the 50th cycle is higher than the capacity retention of the rechargeable lithium battery cells fabricated according to Comparative Examples 1 through 3 at the 50th cycle. Therefore, the rechargeable lithium battery cells including the negative active material constructed as one embodiment of this disclosure have improved cycle life characteristics.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A negative electrode for a rechargeable lithium battery, comprising:
a current collector; and
a negative active material layer disposed on the current collector, and the negative active material layer comprising:
a negative active material including a silicon-based core and a carbon layer disposed on a surface of the silicon-based core,
an inorganic salt including an alkaline metal cation selected from a Na (Sodium) cation, a K (Potassium) cation, or a combination of these, and an anion selected from a carbonate anion, a halogen anion, or a combination of these, and
an aqueous binder.

2. The negative electrode of claim 1, wherein the silicon-based core comprises Si, SiOₓ (0<x<2), a Si—Z alloy (where Z is an element selected from the group consisting of an alkaline metal, an alkaline-earth metal, a group 13 element, a group 14 element, a transition element, a rare earth element, and a combination of these, and not Si), or a combination of these.

3. The negative electrode of claim 1, wherein the carbon layer comprises an amorphous carbon.

4. The negative electrode of claim 1, wherein the carbon layer comprises an amorphous carbon selected from the group consisting of soft carbon (low-temperature fired carbon), hard carbon, mesophase pitch carbide, fired coke and a mixture of these.

5. The negative electrode of claim 1, wherein a content of the carbon layer ranges from about 1 part by weight to about 20 parts by weight based on 100 parts by weight of the negative active material.

6. The negative electrode of claim 1, wherein a thickness of the carbon layer ranges from about 1 nm to about 100 nm.

7. The negative electrode of claim 1, wherein the negative active material has an average particle diameter of about 1 μm to about 20 μm.

8. The negative electrode of claim 1, wherein the inorganic salt comprises K₂CO₃, KCl, KF, Na₂CO₃, NaCl, Nap, or a combination of these.

9. The negative electrode of claim 1, wherein a content of the inorganic salt ranges from about 0.1 part by weight to about 10 parts by weight based on 100 parts by weight of the total weight of the negative active material layer.

10. The negative electrode of claim 1, wherein the aqueous binder comprises one selected from carboxylmethylcellulose, polyvinylchloride, polyacrylic acid, a styrene-butadiene rubber, or a combination of these.

11. A rechargeable lithium battery, comprising:
a negative electrode comprising a current collector and a negative active material composition, the negative active material composition comprising a negative active material including a silicon-based core and a carbon layer disposed on a surface of the silicon-based core, an inorganic salt, and an aqueous binder;
a positive electrode including a positive active material; and
a non-aqueous electrolyte.

12. The rechargeable lithium battery of claim 11, wherein the silicon-based core comprises Si, SiOₓ (0<x<2), a Si—Z alloy (where Z is an element selected from the group consisting of an alkaline metal, an alkaline-earth metal, a group 13 element, a group 14 element, a transition element, a rare earth element, and a combination of these, and not Si), or a combination of these.

13. The rechargeable lithium battery of claim 11, wherein the carbon layer comprises an amorphous carbon.

14. The rechargeable lithium battery of claim 11, wherein the carbon layer comprises an amorphous carbon selected from the group consisting of soft carbon (low-temperature fired carbon), hard carbon, mesophase pitch carbide, fired coke and a mixture of these.

15. The rechargeable lithium battery of claim 11, wherein a content of the carbon layer ranges from about 1 part by weight to about 20 parts by weight based on 100 parts by weight of the negative active material.

16. The rechargeable lithium battery of claim 11, wherein a thickness of the carbon layer ranges from about 1 nm to about 100 nm.

17. The rechargeable lithium battery of claim 11, wherein the negative active material has an average particle diameter of about 1 μm to about 20 μm.

18. The rechargeable lithium battery of claim 11, wherein a content of the inorganic salt ranges from about 0.1 part by weight to about 10 parts by weight based on 100 parts by weight of the total weight of the negative active material composition including the negative active material, the inorganic salt, and the aqueous binder.

19. A rechargeable lithium, battery, comprising:
a negative electrode comprising a first current collector and a negative active material composition disposed on the first current collector, the negative active material composition comprising a negative active material including a silicon-based core and a carbon layer disposed on a surface of the silicon-based core, an inorganic salt, and an aqueous binder;
a positive electrode including a second current collector and a positive active material layer disposed on the second current collector, the positive active material layer comprising lithiated intercalation compounds that reversibly intercalate and deintercalate lithium ions, and the positive active material layer comprising a composite oxide including at least one selected from the group consisting of cobalt, manganese, nickel, and lithium; and
a non-aqueous electrolyte.
